(19) United States
(12) Patent Application Publication
(10) Pub. No.: US 2011/0265353 A1
(43) Pub. Date: Nov. 3, 2011

(54) Plow shovel

(76) Inventor: Frederick David Kaplan, Dix Hills, NY (US)

(21) Appl. No.: 13/066,577

(22) Filed: Apr. 18, 2011

Related U.S. Application Data
(60) Provisional application No. 61/343,327, filed on Apr. 28, 2010.

(51) Int. Cl. E01H 5/02; A01B 1/00

(52) U.S. Cl. 37/197; 37/278; 172/371; 294/59

(57) ABSTRACT

A plow shovel configured to create a path in snow by pushing the snow along a surface without lifting the snow. The plow shovel has a handle attached to a scoop having a first side and a second side. The scoop has a multi-sided plow component configured to part snow and makes a path without lifting the shovel as the plow shovel is pushed forward. A method of clearing a path in snow using the plow shovel described is also provided.

### CROSS REFERENCE TO RELATED APPLICATIONS

This application claims the benefit of U.S. Provisional Application No. 61/343,327, filed Apr. 28, 2010, the contents of which are incorporated herein by reference.

### FIELD OF THE INVENTION

The present invention relates to a plow shovel and more particularly pertains to a shovel designed to easily create a path in snow by pushing rather than lifting and throwing snow so as to reduce muscle and back strain that is common to shoveling. The shovel may also be used to make paths in materials other than snow, such as sand, gravel, soil, mulch, garbage, man-made materials and combinations thereof.

### BACKGROUND OF THE INVENTION

The use of snow removal devices is known in the prior art. More specifically, snow removal devices heretofore devised and utilized for the purpose of removing snow are known to consist basically of familiar, expected and obvious structural configurations, notwithstanding the myriad of designs encompassed by the crowded prior art that have been developed for the fulfillment of countless objectives and requirements.

While the devices available in the prior art fulfill their respective, particular objective and requirements, many if not all require the strain of lifting snow off of the ground in order to clear a path on walkways, sidewalks and driveways. In this respect, the plow shovel according to the present invention substantially departs from the conventional concepts and designs of the prior art, and in doing so provides an apparatus primarily developed for the purpose of allowing easy removal of snow from walkways, sidewalks and driveways with less effort, reduced muscle strain and back pain.

Therefore, it can be appreciated that there exists a continuing need for a new and improved plow shovel that can be used for creating paths and removing snow from sidewalks and driveways. In this regard, the present invention substantially fulfills this need.

### SUMMARY OF THE INVENTION

The present invention is directed to a plow shovel having a handle and a scoop (or blade). The scoop is configured to have a first side and a second side and is attached to the handle much like a convention shovel. The plow shovel further comprises a multi-sided plow component configured to part snow when thrusted into a body of freshly packed snow. The path is made without lifting the shovel since the plow shovel pushes the snow to the side as it pushed forward along the ground. The multi-sided plow component of the present invention is either attached to the first side of the scoop or in the alternative is molded as a single unit.

The configuration of the plow shovel of the present invention in accordance is equipped with several features within the principles of the present invention that allows a person pushing the plow shovel to make a path in the snow without lifting the snow and experiencing back strain. For example, one feature is the shape of the handle. The handle of the plow shovel can be designed to provide amble surface for the user to lean into the shovel so as to provide enough forward thrust to easily and effortlessly make a path in the snow. That is the end portion of the handle is elongated so to have increased surface area that comes in contact with the user while pushing. As further described below the increased surface area of handle displaces the pressure placed on the hands, chest or body of the user when pushing the plow shovel thereby reducing muscle strain. The handle can be padded or separate “handle gloves” can be sold to further cushion the handle.

In one embodiment of the present invention, the multi-sided plow component in accordance with the principles of the present invention as described above has a first face, a second face, a right face having a right side edge, and a left face having a left side edge. The first face is either part of or is in contact with a first side of the scoop and the right and left faces of the plow comes together to form an apex at the leading edge of the plow component. The leading edge of the plow shovel is configured to cut through snow as the plow shovel is pushed forward. The left, right and second faces of the multi-sided plow component of the plow shovel can be convex, concave, flat, or a combination thereof. The plow component can be hollow, foam filled, or structurally reinforced to endure the pressures experienced when snow is pushed against the snow when pushing the snow to the sides.

In another embodiment of the present invention the plow shovel comprises a handle having an elongated pole structure connected to a grip handle at one end and an attachment means to attach to the scoop at the other. The scoop has a front, back, top edge, lower edge, left edge and right edge and an underside that is where the handle attaches. The scoop is configured to have a right concave portion and a left concave portion. The right concave portion has first and second opposing edges wherein the first edge is connected to the right edge of the scoop and the second edge is connected to the lower front edge of the scoop so that the right concave portion is angled to the right. Similarly, the left concave portion has first and second opposing edges. The first edge is connected to the left edge of the scoop and the second edge is connected to the lower front edge of the scoop so that the left concave portion is angled to the left and the second edges of the right and left concave portions meet to form an apex. The apex is configured to part snow and makes a path without lifting the shovel as the plow shovel is pushed forward through the snow.

In yet another embodiment of the present invention, the plow shovel in accordance with the principles of the present invention further comprises at least one ski runner and/or wheels wherein the ski runners have a flat portion and a curved portion. The flat portion and the curved portion each of the ski-runner have a bottom surface and a top surface wherein the bottom surface is configured to contact the snow covered surface to be plowed when the plow shovel is at an angle between about (30) thirty and about (50) fifty degrees with the ground surface so as to allow the shovel to glide across the surface with reduced friction. The ski runner(s) reduces the amount of thrust necessary to push the shovel through the snow. The snow shovel can also be equipped with wheels that are strategically located behind the scoop and designed to support the weight of the shovel and snow that allows the scoop to move with reduced drag along the snow cleared path. This feature further reduces muscle and back strain when using the plow shovel.

Still yet another embodiment of the present invention is directed to an attachment that can attach to a standard shovel having a scoop and a handle so as to convert the standard shovel to a plow shovel that easier on the back of the user. The attachment has a multi-sided plow component configured to part snow and makes a path without lifting the shovel as the plow shovel is pushed forward. The multi-sided plow component can be attached to the scoop of the standard shovel by an attachment means configured to attach the multi-sided plow component to the a scoop of the standard shovel so as to transform the standard shovel scoop into a plow shovel.

The present invention is also directed to method of shoveling using the plow shovel of the present invention.

The above described features, together with other objects and advantages of the present invention which will become subsequently apparent, reside in the details of construction and operation as more fully hereinafter described and claimed, reference being had to the accompanying drawings forming a part hereof, wherein like numerals refer to like parts throughout.

These and other objects of the present invention will become readily apparent upon further review of the following specification and drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a left side view of the preferred embodiment of the plow shovel in accordance with the principles of the present invention.

FIG. 2 is a front view of the preferred embodiment of the plow shovel in accordance with the principles of the present invention.

FIG. 3 is a right side view of the preferred embodiment of the plow shovel in accordance with the principles of the present invention.

FIG. 4 shows the right side view of the preferred embodiment of the plow shovel shown in FIG. 3 having a ski runner in accordance with the principles of the present invention.

FIG. 5 shows the right side view of the preferred embodiment of the plow shovel shown in FIG. 4 further comprising a set of wheels in accordance with the principles of the present invention.

FIG. 6 shows a front view of a retrofit attachment to an existing shovel in accordance with the principles of the present invention.

FIG. 7 shows a rear view of a retrofit attachment to an existing shovel in accordance with the principles of the present invention.

The same reference numerals refer to the same parts through the various figures.

### DETAILED DESCRIPTION OF THE INVENTION

The present invention may be understood more readily by reference to the following detailed description of the invention taken in connection with the accompanying drawing figures, which form a part of this disclosure and in which like numbers indicate like features. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value.

When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”. As used herein, “comprising”, containing”, “characterized by” and grammatical equivalents thereof are inclusive or open-ended terms that do not exclude additional, non-recited elements or method steps, but will also be understood to include the more restrictive terms “consisting of” and “consisting essentially of.”

The following discussion includes a description of the plow shovel of the present invention, related components and exemplary methods of employing the plow shovel in accordance with the principles of the present disclosure. More particularly, the exemplary embodiments of the plow shovel and plow shovel attachment of the present invention are particularly suitable for use in moderate to heavy snow to make a path in the snow without straining to lift the snow to move it out of the way. The plow shovel of the invention is especially useful in creating a path on a walkway or sidewalk after a snowfall has occurred. In some cities the owner of the property must create a pathway on a sidewalk within a short period of time after the snow has ended or the owner can be subject to fines. The plow shovel of the present invention is well suited for people of all ages to meet these requirements. Additional embodiments are also disclosed. Reference will now be made in detail to the exemplary embodiments of the present disclosure, which are illustrated in the accompanying figures.

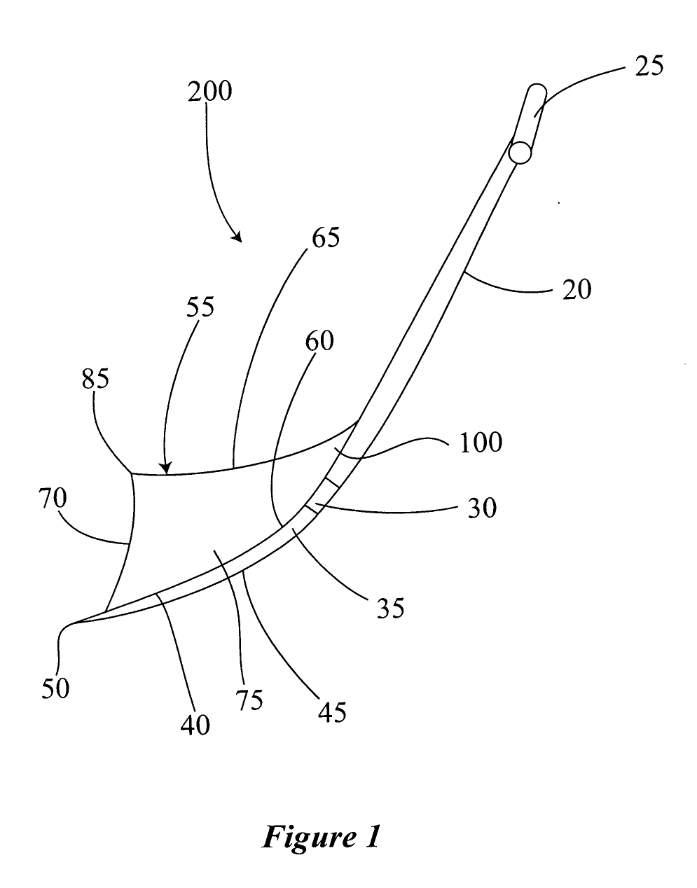

With reference now to the drawings, and in particular, to FIGS. 1 through 5 thereof, the preferred embodiment of the new and improved plow shovel embodying the principles and concepts of the present invention and generally designated by the reference numbers in FIGS. 1-5 will be described.

A plow shovel that allows a user to create a path in snow by pushing snow out of the path in accordance with the principles and objectives of the present invention is provided. The plow shovel of the present invention satisfies this need for a manually pushed snow shovel with which the user's natural forward and upward pushing force on the shovel handle alleviates rather than intensifies stalling friction with the ground and creates a path in the snow without experiencing back injuries and pain associated with conventional shovels.

One embodiment of the manually pushed plow shovel of the present invention comprises a scoop (or blade) and a handle, the handle being attached or directly molded to the scoop. Viewed from the top, the scoop can be substantially in the shape of a triangular prism with convex, concave, flat sides or a combination of each configuration. For example, the top of the multi-sided plow component can be concave or flat while the other faces can be convex. The triangular prism is positioned with the base of the triangular prism attached to a first side (or face) of the scoop. In the alternative, the triangular prism plow and the scoop can be molded as one unit with the base of the triangular prism plow making up part of the scoop.

In one particular embodiment of the present invention, the multi-sided plow component of the present invention is shaped as a triangular prism having a front face, a rear face, and three sides in which one of the sides acts as a base. As stated above, the base of the triangular prism can be part of or in contact with the first side or face of the scoop with the apex of the triangular prism facing forward. That is, the apex and the leading edge of the scoop are the first parts of the plow component to come in contact with snow, as the plow shovel is thrusted in the forward direction. This configuration allows the snow to be split and flow down the sides of the of the triangular prism shaped plow component to the sides thereby making it easy for the shovel to cut through the snow to make a path.

As also stated above, the left and right sides of the triangular prism can be concave, flat or convex. Convex sides would bulge outward and cause the snow to travel outward to the back as the plow shovel is pushed through the snow. A plow shovel having concave sides would part and scoop the snow and eventually push the snow to the sides as the plow shovel is advanced. Alternatively, a triangular prism shaped plow component having flat sides would cut through the snow and displace the snow straight back as the plow is pushed forward. Although each of these configurations have their benefits and pitfalls, all of these designs fall with the inventive scope of the present invention and can be used to create the plow shovel of the present invention.

In one embodiment of the present invention, the scoop of the plow shovel has a ground leading edge that is designed to cut the snow as close to the ground as possible so that it can be displaced by the plow component as the plow shovel is advanced forward to create a path in the snow. The top surface of the triangular prism shaped plow component of the present invention can extended over the handle at a curved angle so as to displace snow forward so that it can then be pushed to either side of the plow component instead of over the top. This is to provide a clear path in the snow and not have snow displaced over the plow component into the path being made by the plow shovel as it is advanced in the forward direction.

In a preferred embodiment of the present invention the left and right sides of the plow component of the present invention are concave so as to displace as much snow to the side as possible. In a more preferred embodiment of the present invention the top face of the plow component is concave and has a higher peak than the back edge of the scoop. At the top edge is a convex portion that has a curl forward with a slight slope to push snow back in front of the shovel or to either side rather than over the top of the plow shovel. That is, this configuration is designed to displace any snow that makes it way over the top face of the plow forward so that it can be pushed to the sides by the left and the right sides of the plow component. This aids in creating a path that is as clean as possible with a single pass.

It is envisioned that variations on the shape of the plow component of the present invention described herein can be used such as flat, bent, hyperbola, prism, ridged, convex, and any combination of these as well as other shapes that aid in making a path in the snow. It is contemplated that all of these shapes fall within the scope of the present invention so as long as the configuration of the plow component displaces snow to each side of the shovel in order to create a path as the shovel is pushed in the forward direction with as little resistance as possible.

To aid in reducing friction between the plow shovel and the snow to be cleared, the plow shovel can be equipped with at least one ski-runner. At least one ski-runner can be attached to or be molded as part of the underside of the scoop (second side). This would reduce friction between the underside of the scoop and the snow thereby reducing the amount of thrust necessary to advance the plow shovel of the present invention in the forward direction. Reducing the amount of thrust that is necessary to advance the plow shovel of the present invention in the forward direction also reduces the amount of effort required by the user to make the path in the snow. Reduced effort leads to a reduction in muscle and back strain and allows the elderly, weak and/or people with handicaps to use the plow shovel of the present invention.

In yet another embodiment of the present invention, the plow shovel of the present invention can be further equipped with wheels. The wheels can be in place of or in addition to the ski-runners. If the wheels are in addition to the ski-runners the wheels may be positioned towards the rear of the ski-runner or even further back from the leading edge so that the scoop would pivot on the wheels when placed on the ground and the ski-runners come in contact with snow at a given angle so as to reduce friction between the plow shovel and the surface being plowed. That is, the wheels will be in contact with the already plowed surface as the plow shovel is advanced forward and creates a path while the ski-runners are in contact with the snow before it is cleared. This allows the plow shovel to glide over the snow by reducing resistance.

The wheels can also aid in wheeling the plow shovel from the garage or on cleared pavement to the place where it is to be used or stored without lifting the shovel. In another embodiment of the present invention, the ski runner(s) is/are configured to pivot in order to glide over uneven surfaces and reduce resistance between the plow shovel and the snow. The ski runners may be either fixed pivotably or not pivotably to the second side of the scoop portion of the plow shovel. The ski runner may resemble the front portion of a conventional downhill ski in that the ski runner is a relatively flat piece with a narrow flat face that gently curves concave upwards to the end. The end may be tapered to form a point. Other configurations of the ski-runners can be used and it is envisioned that all of these embodiments fall within the objectives of the present invention.

As stated above, in the preferred embodiment of the present invention, there can be two ski runners attached to the second side (underside) of the scoop. Additional ski runners may be used to enhance stability. Viewed from the top, the ski runner(s) extend perpendicularly from the leading edge and are thereby aligned with the track of forward shovel motion when the shovel is in use. Each ski runner has a flat portion that transition into a gently curved or upwards inclining portion leading to a narrowed tip. The gently curved portions of the ski runners are positioned concave up relative to the front face of the blade and away from the ground surface when the shovel is in use. The ski-runners must be positioned so that they do not block the leading edge since doing so would obstruct snow removal efforts.

The scoop of the plow shovel of the present invention is preferably configured with upward incline from the leading edge to the back edge of the scoop that is attached to the handle. This allows the user to have a built in angle that aids in pushing along the snow. This angle allow the user to stand in an upright position and provide enough pitch to displace snow to the sides as the plow shovel is pushed through the snow, thereby creating a path in the snow. This incline is preferred to be a gentle curvature like the forward end of a snow ski. A scoop with a gentle curvature is preferred since it is less likely to stall on rough ground, in heavy wet snow, on uneven iced surfaces or fall into divots and depressions that may be present on the surface being cleared.

A typical operating position of the shovel with the ground as viewed from the side is approximately 20 to about 50 degrees. This angle is described as approximately thirty to about 50 degrees because it is expected that the angle/pitch of the shovel changes with the height of the person using the shovel and will be actually be between about 30 and about 45 degrees for the average individual depending on the comfort level of the user during forward motion and pivoting of the shovel. The ski runners and wheels can be non-permanently attached to the shovel by screws or other means so that they can be changed or adjusted if necessary.

It is also envisioned that the bottoms of the ski runners, as well as, the underside surface of the scoop may be coated with a non-stick composition such as paraffin, Silverstone®, Teflon® or the like. This coating not only reduces wear but also reduces resistance between the shovel and the ground as it slides across the snow.

The handle of the device of the present invention is an elongated shaft with an attachment means on one end of the shaft and a formed handle on the other end. The elongated shaft can be spherical, rectangular or triangular in dimension and can have an angle to enhance pushing of the plow shovel through the snow. In the alternative, the handle can be shaped in an ergonomically favorable configuration so as to further reduce strain on the user's muscles and back when using the shovel. Still further, the handle can be attached so that the user so as to arrive at a comfortable position can adjust the length and angle of attachment of the handle to the scoop portion of the plow shovel. The handle can be straight or ergonomically designed in an angled fashion. These features are designed to enhance the basic structure of the plow shovel of the present invention but are not required in order achieve the main objectives of the present invention, namely to all provide a shovel that can be used to clear snow without lifting and throwing the snow out of the way straining muscles and injuring the back of the user.

The present invention will now be described in connection with FIGS. 1-5. FIG. 1 is a left side view of the preferred embodiment of the plow shovel in accordance with the principles of the present invention. As shown in FIG. 1 the plow shovel (10) has basically three main components connected or molded together as a single unit. These components are the handle (20) the scoop (35) and the multi-sided plow component (55) attached to the scoop (35). The handle (20) can be equipped with a push bar (25) that is configured as an extended cross bar so that a user can put additional force into pushing the plow shovel (10) by leaning into the push bar (25) without injuring his or her body. That is, a larger push bar (25) distributes the pressure exerted against the push bar (25) over a larger area so as to reduce trauma to muscle in which it is pressed against.

The handle (20) is attached to the scoop (35) at an attachment joint (30) at an angle as described in the general discussion directly above. In the alternative, the handle (20) can be directly molded to the scoop (35) or threaded into the scoop at attachment joint (30). Other attachment means can be used and are within the scope of the invention.

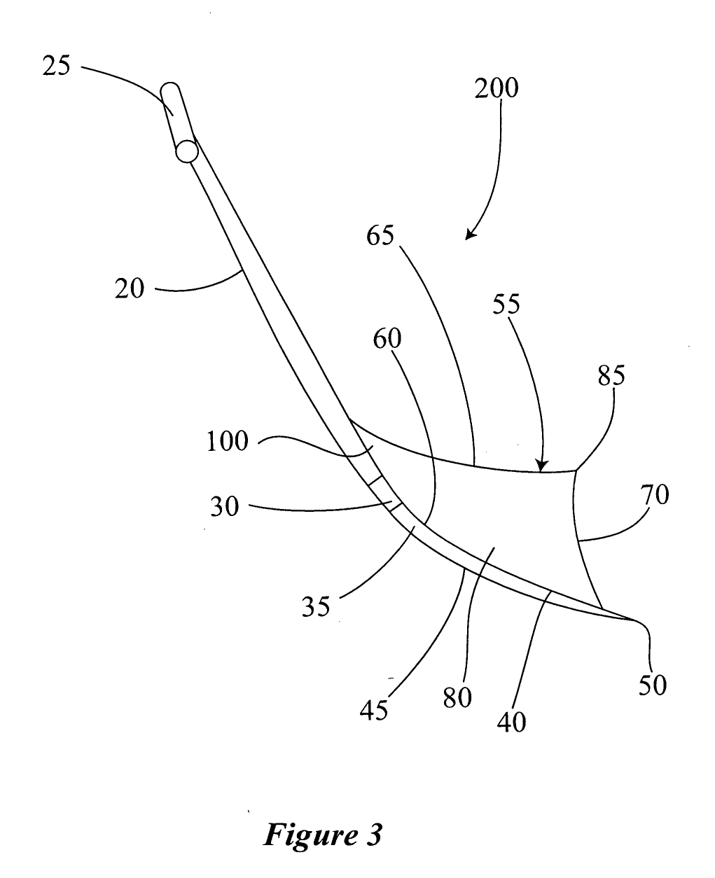

The multi-sided plow component (55) can have multiple shapes. As shown in FIG. 1 the preferred embodiment is substantially similar to a triangular prism. The multi-sided plow component (55) has a leading edge (70), apex (85), a top surface (65) a bottom surface (45), a left side (75), a right side (80) (shown in FIG. 3) and a base (60). The base (60) is attached to the first side (40) of the scoop (35) or in the alternative is molded as part of the scoop (35). The scoop (35) has a ground leading edge (50) that extends pass the leading edge of the plow component (70) that is configured to get as close to the ground as possible as the shovel is advanced forward and makes a path.

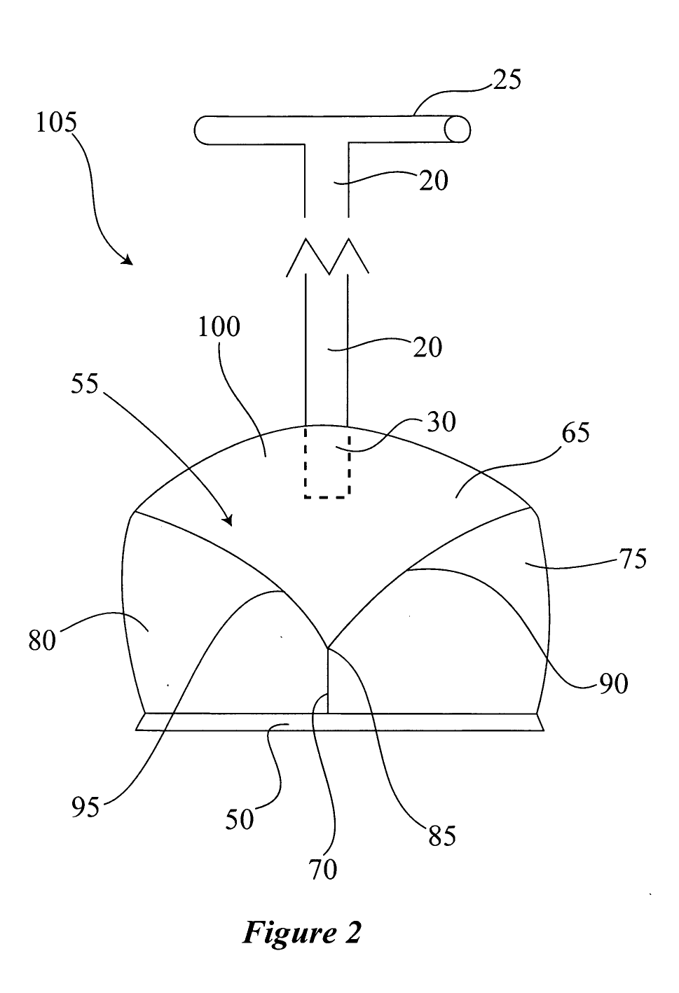

As discussed in the general discussion above, the left side (75), the right side (80) (as shown in FIG. 2) as well as the top surface (65) of the plow component (55) can be concave, convex or substantially flat. The preferred embodiment shown in the Figures have concave sides and a convex top surface with a curl forward so that snow can be better displaced to the sides as the shovel is advanced in the forward direction.

FIG. 2 shows a front view of the preferred embodiment of the plow shovel (105) and FIG. 3 shows a right side view of the preferred embodiment of the plow shovel (200) in accordance with the principles of the present invention. The multi-sided plow component (55) has a leading edge (70), apex (85), a top surface (65), a left side (75) (shown in FIG. 2), a right side (80) (shown in FIG. 3) and a leading edge (50), edge of the right side (95) and edge of the left side (90). As shown in FIG. 1, the top surface (65) of the plow component (55) has a raised portion (100) with a peak that is designed so that snow can flow to the sides of the plow component with a minimal amount flowing over the shovel. This portion is also where the handle (20) is attached to the scoop (35)/plow component (55).

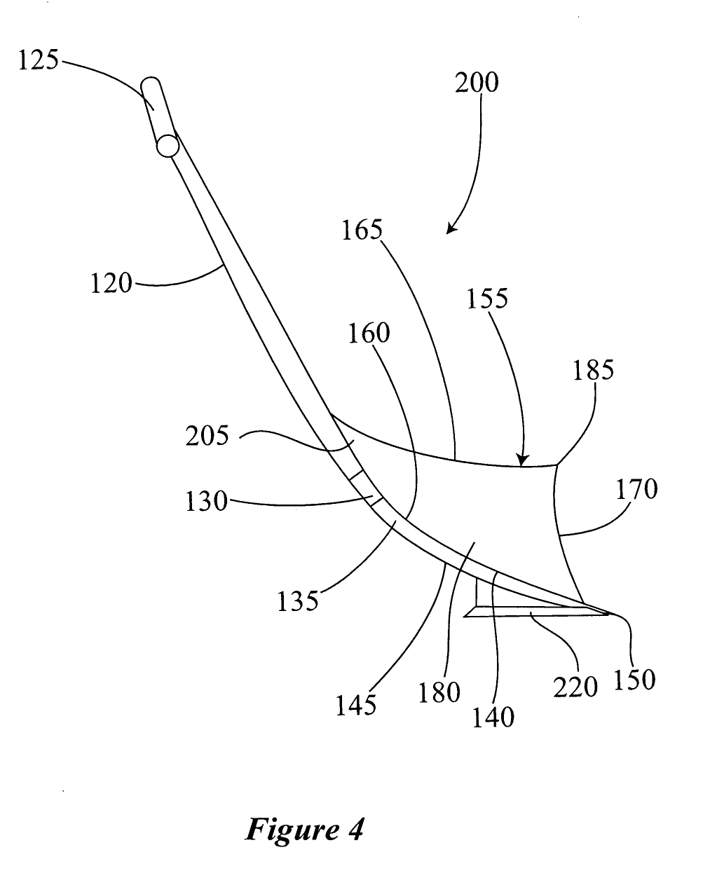

FIG. 4 shows a right side view of the preferred embodiment of the plow shovel (200) shown in FIG. 3 having a ski runner (220) in accordance with the principles of the present invention. The ski-runner (220) is attached to the underside (145) of the scoop (135) and is designed to reduce the friction between the underside (145) of the scoop (135) and a snow-covered surface that is to be plowed. The ski-runner (220) can span the entire width of the scoop (220) or in the alternative the scoop (135) can be equipped with multiple ski-runners (220) strategically positioned on the outer portion and middle of the underside (145) of the scoop (135) to support the weight of the snow being plowed. Other designs and positioning can also be used.

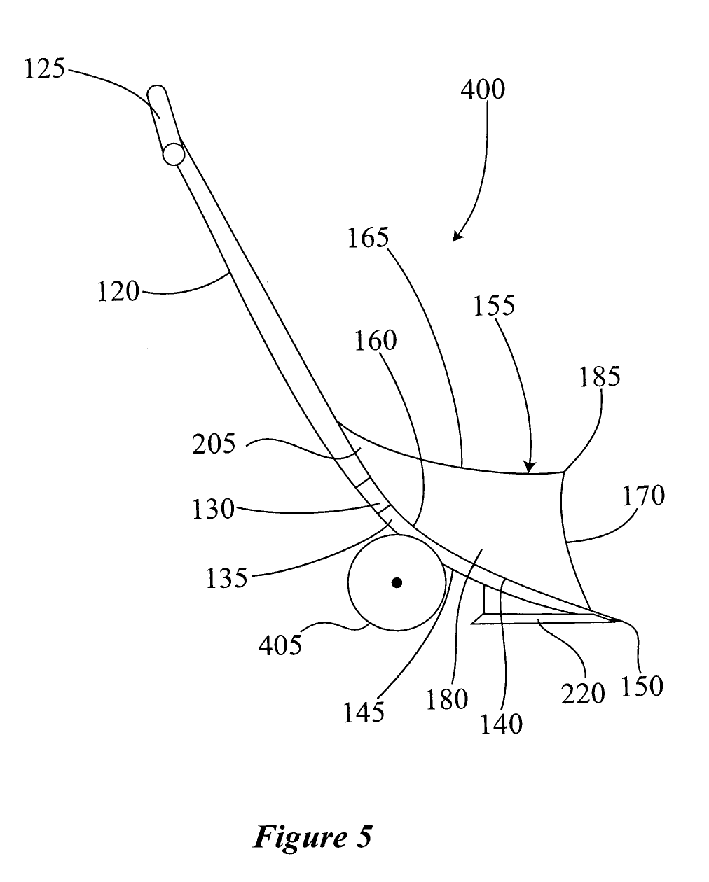

FIG. 5 shows a right side view of the preferred embodiment of the plow shovel (400) shown in FIG. 3 having a ski runner (220) and a plurality of wheels (405) in accordance with the principles of the present invention. As discussed above, the ski-runner positioned at the leading edge of the snow shovel is designed so as to reduce friction between the surface to be plowed and the plow shovel while not obstructing the path of the shovel. In this same regard, the wheels (405) are positioned on the underside (145) of the scoop (135) and are set back from the ski-runner and ground level leading edge. The positioning of the wheels (405) can be adjustable or can be set from the factory. The wheels (405) assist in the movement of the plow shovel (400) across the already plowed surface, since the wheels (405) are positioned behind the scoop (135). The wheels (405) also assist in supporting the weight of the snow being parted by the plow shovel and helps create a path in the snow with reduced effort. That is, the reduced friction between the underside (145) of the scoop (135) and the snow covered surface as it is pushed across the snow and the movement of the wheels (405) across the cleared surface behind the scoop (135) both contribute to a reduced friction of the plow shovel as it is pushed to make a path in the snow. Reduced friction, results in less thrust being required which makes using the plow shovel to clear a path in the snow even easier than originally believed. The reduced effort required to push the plow shovel results in reduce muscle strain and back pain experienced by the user after clearing the sidewalk, steps, walkway or the driveway.

Different types of wheels can be used including wheels that require an axle and those that do not. The wheels can be filled with air so as to give a slight bounce to the plow shovel when it is pushed or can be solid. As mentioned above the positioning of the wheels is also important. The positioning of the wheels changes the angle of the plow shovel. Some deluxe models of the plow shovel can be equipped with an adjustable wheel axle that allows the wheels to move towards and away from the leading edge of the snow shovel on a track (not shown) so as to provide the proper angle an height of the plow shovel in accordance with the present invention. The wheels will also aid in getting the plow shovel out of the garage without carrying it, which further reduces, muscle strain and/or back strain. Other configurations of the wheels (405) can be used and are contemplated and envisioned to fall within the general principles of the present invention.

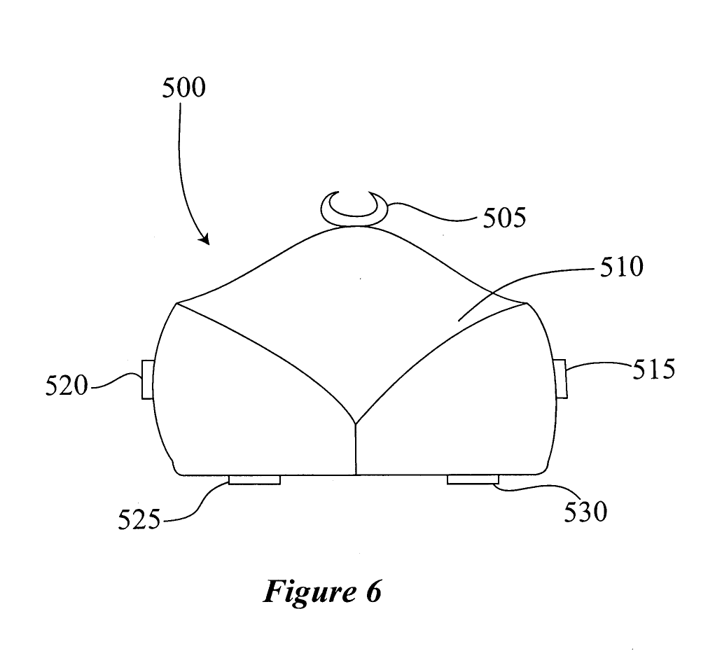

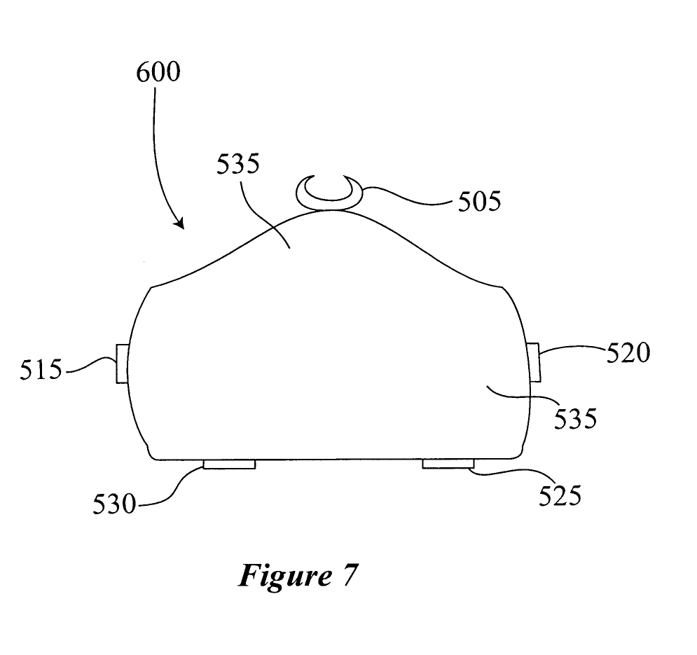

In another embodiment of the present invention and a plow attachment is provided that when attached to an ordinary snow shovel transforms the ordinary snow shovel into a plow shovel as described above. FIG. 6 and FIG. 7 show front and side views of this embodiment. The attachment can be attached or detached to a shovel according to the user's desire thereby allowing the user to decide whether the task at hand requires a plow shovel or an ordinary shovel.

FIG. 6 shows a the plow portion (500) of the plow shovel described in FIGS. 1-5 fitted with attachment means on each side edge of the plow portion as well as the leading edge. The attachment means located on the right side (515) and left side (520) are designed so as to attach the plow portion to the scoop or blade of a regular shovel in a firm, fixed orientation. The attachment means can be use clipping, friction fit, or faceting mechanisms to firmly attach the plow shovel portion to an existing shovel. These and other attachment means as is known in the art can be used for attachment and fall within the scope of the present invention. Similarly, located on the leading edges of the plow attachment are additional attachment means (525) and (530) that are configured to attach to a leading edge of the scoop or blade of a regular shovel. The leading edge attachment means of the present invention are strategically placed on or in the leading edge area so that the plow means will be forced back into the scoop of the shovel as it is advance threw the snow. That is, the forward force of the snow against the plow pushes the plow shovel further into the scoop instead of away from the scoop, thereby keeping the shovel means attached to the scoop of a standard shovel.

It is understood that the leading edge attachment means are positioned in such away as to not interfere the movement of the shovel or create friction between the surface being plowed and the leading edge of the shovel when advanced in the forward direction. The attachment means can also be part of the ski runners and configured so that the ski runners attach the leading edge of the plow portion to the leading edge of the scoop and still function as the ski runners described above with reference to the other figures.

Finally, the upper section (510) of the plow shovel portion (500) is fitted with an attachment means (505) configured to attach to the handle of a standard shovel. Attachment means (505) can be configured to be a half open circle and is made of a material having a memory. That is, as the half circle attachment means is pressed against the round pole it expands and tightly presses against the pole handle to firmly grip and attach the top of the shovel to the handle. This, as well as, all of the attachment means used to attach the plow shovel to a standard shovel can be made to be permanent or to be removable. The type used will depend on the particular model of the device. It is also understood that additional attachment means can be used to attach the plow portion to a shovel and fall with the scope of the present invention.

FIG. 7 shows the rear portion of the plow attachment (600) described in FIG. 6 and has all of the attachment means described therein. This attachment means can be configured to be hollow, foam filled or reinforced with cross sections (535) so as to provide strength without having the weight of a solid piece. Various combinations of solid, reinforced and foam filled plow attachments can be used and are deemed to fall within the scope of the present invention.

The plow shovel as well as the plow shovel attachment can be made of anodized metal, aluminum alloy, alloys, reinforced plastics, rubber coated metal, stainless steel, manmade materials and combinations thereof. Many plastics and fiber-reinforced plastics can be molded to form the plow shovel shape, however, slippery and strong thermo-plastics like nylon and high-density polyethylene are preferred. A metal overlay coating may protect the leading edge when the scoop is made of plastic or soft metal like aluminum so as to add additional durability.

The plow shovel of the present invention can be made of multiple parts and assembled using standard technology or welding or in the alternative can be molded or forged as a single unit from a mold. The way in which the plow shovel of the present invention is assembled and the materials used are a design choice that has to due with the environment in which it is to be used, the model, and the cost basis of the plow shovel. All techniques used to manufacture the plow shovel of the present invention are well known and can be used to produce the plow shovel.

The present invention has price economy over prior art while providing unique characteristics not previously possible. The invention is simple in that, as discussed above, it can be made cheaply with very few parts. The scoop and multi-sided plow component can be manufactured as a single molded piece or manufactured separately and assembled. The handle can be as simple as a wooden or plastic broom handle so long as it is firmly attached to the blade and support the pressure used to push the plow shovel. The connection of the handle to the scoop can be a threaded coupling or can be attached by a facet or molded directly to the scoop. In the alternative, the handle, scoop and multi-sided plow component can be also molded as one piece. The ski runners and/or wheels can be configured as a separate piece that can be added to the bottom of the scoop or can also be molded as part of the scoop. However, it is essential that the bottom of the ski-runner, whether molded directly to the scoop or attached, the bottom of the ski-runner(s) must be smooth so as to reduce friction of the scoop without disturbing the work efficiency of the invention.

As to the manner in which the plow shovel of the present invention is used should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A plow shovel, comprising:
an elongated handle;
a scoop having a front surface, a back surface that is the reverse side of said front surface, a leading edge, a right side edge and a left side edge said scoop is attached to said handle, and
a multi-sided plow component configured to part snow and make a path without lifting said shovel as said plow shovel is pushed forward, said multi-sided plow component is attached to or is part of said front surface of said scoop.

2. The plow shovel of claim 1 wherein said multi-sided plow component is in the shape of a prism and has a right face having first and second side edges, and a left face having first and second side edges wherein said first side edge of said right face and said first side edge of said left face are attached to form an apex at said leading edge of said scoop that is configured to cut through snow when said plow shovel is pushed forward; and
said second side edge of said right face is attached to said right side edge of said scoop and said second side edge of said left face is attached to said left side edge of said scoop to form a plow structure having an apex at said leading edge of said scoop and right and left faces angled back, said plow shovel having a prism configuration designed to part snow and make a path without lifting said plow shovel as said plow shovel is pushed forward.

3. The plow shovel of claim 2 wherein said right and left concave portions are connected on a top portion by a surface that is configured to allow snow to pass over it as said plow shovel is advanced through snow.

4. The plow shovel of claim 2 wherein said left face, said right face are each configured to be convex, concave, flat, or a combination thereof.

5. The plow shovel of claim 2 further comprising at least one ski runner having a flat portion and a curved portion, said flat portion and said curved portion each having a bottom surface and a top surface, said bottom surface configured to contact with a ground surface to be plowed when said plow shovel is at an approximately thirty degree angle with the ground surface.

6. The plow shovel of claim 2 further comprising a plurality of wheels attached to the underside portion of said scoop.

7. A plow shovel, comprising:
a handle having and elongated shaft with a grip at one end and an attachment means at the opposite end;
a scoop, said scoop having a front, back, top edge, lower edge, left edge and right edge and an underside attached to said handle, said scoop configured to have a right concave portion and a left concave portion;
said right concave portion having first and second opposing edges, said first edge connected to said right edge of said scoop and said second edge connected to said lower front edge of said scoop so that said right concave portion is angled to the right; and
said left concave portion having first and second opposing edges, said first edge connected to said left edge of said scoop and said second edge connected to said lower front edge of said scoop so that said left concave portion is angled to the left and said second edges of said right and left concave portions meet to form an apex configured to part snow and make a path without lifting said shovel as said plow shovel is pushed forward.

8. The plow shovel of claim 7 wherein said right and left concave portions are connected on a top portion by a surface that is configured to allow snow to pass over it as said shovel is advanced through snow.

9. The plow shovel of claim 7 wherein said top portion is concave, flat or convex.

10. The plow shovel of claim 7 further comprising a curved lip portion positioned along a back portion of said scoop said curved lip portion configured to direct snow towards the said front of said scoop as said shovel is advanced through snow.

11. The plow shovel of claim 7 further comprising a plurality of wheels attached to the underside portion of said scoop so as to facilitate movement of said shovel across a surface.

12. The plow shovel of claim 7 further comprising at least one ski runner attached to the underside of said scoop, said ski runner having a flat portion and a curved portion, said flat portion and said curved portion each having a bottom surface and a top surface, said bottom surface configured to contact with a ground surface to be plowed when said plow shovel is at an approximately thirty degree angle with the ground surface.

13. A method of plowing a path in snow comprising;
a) positioning said plow shovel of claim 1 at a desired angle with the ground with said handle positioned either against a user's body or in said user's hands so that thrust can be applied;
b) applying a forward thrust against said handle so as to push said plow shovel in the forward direction and create a path in snow as said plow shovel is advanced forward; and
c) continuing steps a) and b) until a path is created.

14. A method of plowing a path in snow comprising;
a) positioning the plow shovel of claim 7 at a desired angle with the ground with said handle positioned either against the user's body or in the user's hands so that thrust can be applied;
b) applying a forward thrust against said handle so as to push said plow shovel in the forward direction and create a path in snow as the plow shovel advances; and
c) continue steps a) and b) until path is created.

15. A shovel attachment, comprising:
a multi-sided plow component configured to part snow and make a path without lifting said plow shovel as said plow shovel is pushed forward, said multi-sided plow component configured to attach to a scoop of a shovel to transform said shovel scoop into a plow shovel.

16. The shovel attachment of claim 15 wherein said multi-sided plow component has a right concave portion and a left concave portion;
said right concave portion having first and second opposing edges connected by a concave face, said first and second edges further comprising attachment means configured to connect said right concave portion to said shovel so that said right concave portion is angled to the right; and
said left concave portion having first and second opposing edges connected by a concave face, said first and second edges further comprising attachment means configured to connect said left concave portion to said shovel so that said left concave portion is angled to the left and said right and left concave portions meet to form an apex at a leading edge of said shovel configured to part snow and make a path without lifting said shovel as said plow shovel is pushed forward.

17. The shovel attachment of claim 16 wherein said right and left concave portions are connected on a top portion by a surface that is configured to allow snow to pass over it as said shovel is advanced through snow.

18. The plow shovel attachment of claim 17 further comprising a curved lip portion positioned along a back portion of said shovel scoop said curved lip portion configured to direct snow towards the said front of said plow shovel as said plow shovel is advanced through snow.

19. The plow shovel attachment of claim 15 further comprising a plurality of wheels attachable to an underside portion of said shovel scoop so as to facilitate movement of said shovel across a surface.

20. The plow shovel attachment of claim 15 further comprising at least one ski runner attached to the underside of said scoop, said ski runner having a flat portion and a curved portion, said flat portion and said curved portion each having a bottom surface and a top surface, said bottom surface configured to contact with a ground surface to be plowed when said plow shovel is at an approximately thirty degree angle with the ground surface.
